(19) United States
(12) Patent Application Publication
(10) Pub. No.: US 2025/0225615 A1
(43) Pub. Date: Jul. 10, 2025

(54) SUPER-RESOLUTION IMAGING VIA PHOTON ENUMERATION

(71) Applicant: Government of the United States of America, as represented by the Secretary of Commerce, Gaithersburg, MD (US)

(72) Inventors: Sergey Vladimirovich Polyakov, Gaithersburg, MD (US); Ivan Alexandrovich Burenkov, Boyds, MD (US)

(21) Appl. No.: 19/013,583

(22) Filed: Jan. 8, 2025

Related U.S. Application Data
(60) Provisional application No. 63/643,640, filed on May 7, 2024.
(60) Provisional application No. 63/618,412, filed on Jan. 8, 2024.

(51) Int. Cl. G06T 3/4053; G01J 1/44; H04N 23/56; H04N 23/71

(52) U.S. Cl. CPC G06T 3/4053; G01J 1/44; H04N 23/56; H04N 23/71; G01J 2001/442

(57) ABSTRACT

A method of super-resolving light sources includes obtaining photon number distributions for each pixel of a spatial image by a photon-number-resolving device, and resolving positions and intensities of imaged light sources via analysis of joint spatial and photon-number-resolving data.

### RELATED APPLICATIONS

This application claims the benefit of U.S. Provisional Patent Application Ser. No. 63/618,412 (filed Jan. 8, 2024), and U.S. Provisional Patent Application Ser. No. 63/643,640 (filed May 7, 2024), each of which is herein incorporated by reference in its entirety.

### FEDERALLY-SPONSORED RESEARCH AND DEVELOPMENT

This invention was made with United States Government support from the National Institute of Standards and Technology (NIST), an agency of the United States Department of Commerce. The Government has certain rights in this invention.

### COPYRIGHT NOTICE

This patent disclosure may contain material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD OF INVENTION

The present invention relates generally to imaging, and more particularly to super resolution of visually adjacent or overlapping light sources.

### BACKGROUND

For over a century, the Abbe-Rayleigh criterion (ARC) was used to determine the diffraction-limited resolution of optical imaging systems. Yet, the fundamental limit for the spatial resolution of an optical instrument is set by laws of quantum physics. Before 1994, the only techniques considered to be able to resolve subdiffractional features were near-field-based techniques. Far-field super-resolution microscopy techniques have advanced rapidly in last three decades, overcoming the diffraction limit of optical resolution by manipulating excitation and fluorescent light properties.

### SUMMARY OF INVENTION

However, achieving super-resolution in situations where sources are uncontrolled remains a challenge. So far, most passive optical super-resolution techniques have been based on the decomposition of spatial modes into suitable transverse modes of light. However, these conventional schemes impose stringent requirements on the alignment and centering conditions of imaging systems and require a priori information regarding the properties of the, in principle, “unknown” light sources such as the number of sources and their relative intensity. Therefore, the performance of this technique degrades significantly in cases of unknown centroid, unequal sources with unknown exitance (commonly known as brightness) ratios, for more than two sources, and other practical deficiencies. Alternatively, the Glauber correlation functions can be used to obtain the number and type of sources and a factor of 2 improvement of the spatial resolution of the imaging system was demonstrated.

Therefore, herein is disclosed an alternative passive super-resolution imaging via photon enumeration (S-RIPE) technique that uses a photon number resolving (PNR) camera which is now available commercially (or spatial raster scan obtained with a single-pixel PNR detector) in place of a conventional camera and, therefore, can enhance any imaging system, including conventional super-resolution systems. A PNR camera (or a single-pixel PNR detector) enables an additional measurement modality and provides extra information on top of the standard mean intensity map. This additional information from the measured photon number distributions enables independent identification of the number and type of sources comprising the image. Although, theoretically, there is no limit on the number of overlapping sources (including single-photon sources such as fluorophores and thermal sources), sub-nm scale resolution of up to five fluorophores with a conventional microscope using exemplary methods and more than an order of magnitude improvement in resolution of five bright thermal states is possible, according to experiment and numerical simulations, e.g.

According to one aspect of the invention, a method of super-resolving light sources includes obtaining a respective photon number distribution for each pixel of a spatial image obtained by a photon-number-resolving device; representing at least one of a plurality of light sources as spatial distributions of mode structures via a point-spread function; and finding a configuration of light sources that best represents an observed plurality of photon number distributions of at least one of the plurality of pixels. The configuration includes at least one of a number or spatial position of the light sources in an object plane.

Optionally, the method includes determining intensity information of each light source imaged by the camera.

Optionally, the method includes determining location information of each light source imaged by the camera.

Optionally, the method includes determining a mode structure via a mode reconstruction algorithm applied to each pixel.

Optionally, the mode reconstruction algorithm includes identifying a set of correlated and uncorrelated optical modes.

Optionally, the mode reconstruction algorithm includes identifying overall optical losses for conjugated fields.

Optionally, the method includes identifying a number of sources by increasing number of sources in a fit model until the fit model returns one of the sources with extracted mean number of photons per unit of time per pixel that is below a user defined threshold.

Optionally, the method includes calculating a joint probability distribution using the equation:

$${P}_{c} ( {N}_{s} , {N}_{i} ) = \text{?} {\prod }_{j} {p}_{{μ}_{j}} ( {k}_{j} ) \text{?} ,$$

$${P}_{u} ( M ) = \text{?} {\prod }_{j} \text{?} ( {k}_{j} ) ,$$

$$P ( {N}_{s} , {N}_{i} ) = \text{?} ,$$

$$\text{?} \text{indicates text missing or illegible when filed}$$

where nₛ, nᵢ are the number of photons detected in signal and idler arms, respectively, underlying modes have probability distributions p_{μ}(n) for mean photon numbers μ, L_{n,k}(η)=ηⁿ(1−η)^{k-n}k!/[(k−n)!n!] are loss probability factors that compute a probability that n≤k photons are measured given transmittance η and k initial photons, and P_{c} and Pᵤ are correlated and uncorrelated parts of the joint probability distribution, respectively.

Optionally, the method includes minimizing an error of nonlinear parametric fit of the joint probability distribution to determine the number and type of light sources imaged by the camera.

Optionally, the photon-number-resolving device is a photon number resolving camera.

Optionally, the photon-number-resolving device is a photon number resolving detector using raster scanning.

According to another aspect, a method of super-resolving light sources includes the steps of obtaining photon number distributions for each pixel of a spatial image by a photon-number-resolving device; and resolving positions and intensities of imaged light sources via analysis of joint spatial, photon-number-resolving data, and a point-spread function of the imaging system.

Optionally, the photon-number-resolving device is a photon number resolving camera.

Optionally, the photon-number-resolving device is a photon number resolving detector using raster scanning.

Optionally, the method includes identifying a number of sources by increasing number of sources in a fit model until the fit model returns one of the sources with extracted mean number of photons per unit of time per pixel that is below a user defined threshold.

According to another aspect, a super-resolution system for super-resolving light sources includes a photon-number-resolving device; a processor configured to: obtain photon number distributions for each pixel of a spatial image from the photon-number-resolving device; and resolve positions and intensities of imaged light sources via analysis of joint spatial, photon-number-resolving data, and a point-spread function of the super-resolution system.

Optionally, the photon-number-resolving device is a photon number resolving camera.

Optionally, the photon-number-resolving device is a photon number resolving detector using raster scanning.

Optionally, the processor is further configured to identify a number of light sources by increasing number of light sources in a fit model until the fit model returns one of the light sources with extracted mean number of photons per unit of time per pixel that is below a user defined threshold.

The foregoing and other features of the invention are hereinafter described in greater detail with reference to the accompanying drawings.

### BRIEF DESCRIPTION OF THE DRAWINGS

FIG. 1 shows an exemplary system with a photon-number-resolving camera imaging a plurality of light sources.

FIG. 2 shows experimental data structure and light source reconstruction for each pixel independently.

FIG. 3 shows an exemplary method of super-resolving light sources with single-pixel mode reconstruction.

FIG. 4 shows an exemplary method of super-resolving light sources with joint spatial and PNR data.

FIG. 5 shows an exemplary computer system for operating exemplary methods.

### DETAILED DESCRIPTION

Exemplary super-resolution methods are based on the statistical properties of the photon number distributions of light sources. The photon number distributions (PNDs) can be very distinct for different light sources and their combinations. That means that one can use a mathematical algorithm to identify the underlying mode structure of a light source by analyzing its PND. Herein are disclosed exemplary super-resolution techniques that use both photon statistics and spatial data to overcome the diffraction limit in optical imaging.

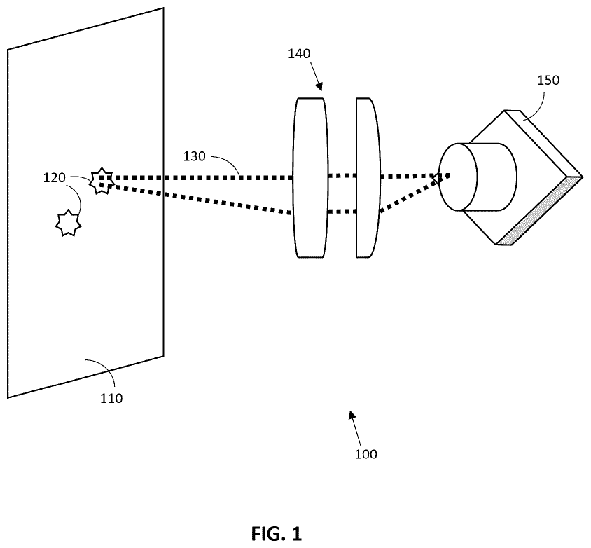

Referring first to FIG. 1, an exemplary system is shown at 100 and includes an object plane 110 with light sources 120 emitting light with a specific photon-number statistics 130 captured by an optical system 140 having one or more optical elements (such as, e.g., lenses) and are detected by a photon number resolving camera or spatial raster scan with a single-pixel PNR detector 150. Single-pixel PNR detector can be also used without raster scan to obtain information about number of light sources, their type and intensities using the S-RIPE technique. However, without a spatial raster scan or a spatial resolution provided by an array of pixels (as in PNR camera) the spatial localization accuracy is limited to the size of spatial area where light is collected by the optical system 140 and transferred effectively to the PNR detector.

To measure PNDs, multiple measurements are taken at each pixel, and probabilities to measure N photons are found for each N, from N=0 to Nmax, where Nmax is chosen to be sufficiently large such that detecting more than Nmax photons in a single measurement is unlikely.

As input data, exemplary methods use PNDs measured in a discrete set of locations (e.g., PNR camera pixels), providing both spatially and photon-number-resolved data. Since photon number distribution is defined by the number and type of different light sources and the mean number of photons produced by each source, we can use it, together with the imaging system's point-spread function (PSF), to improve the identification and the localization of the light sources. We use nonlinear model fit to identify positions and mean number of photons of multiple light sources with strongly overlapping PSF from the experimental data. In another embodiment of the invention other algorithms suitable for parameter extraction can be used, such as but not limited to maximum likelihood estimation, Bayesian inference, etc. The model can include multiple thermal and single-photon sources and one coherent source: each source characterized by mean number of photons emitted per unit of time, and spatial coordinates that are extracted by the S-RIPE technique. PSF parameters generally can be measured for an imaging system and fixed into the model. Still, one can use PSF width as a fitting parameter and extract this information from the raw data using exemplary methods. The number of modes can also be determined by the method. If the number of sources in the model exceeds the number of sources in the data, the methods return extra sources unpopulated (with a mean number of photons close to zero).

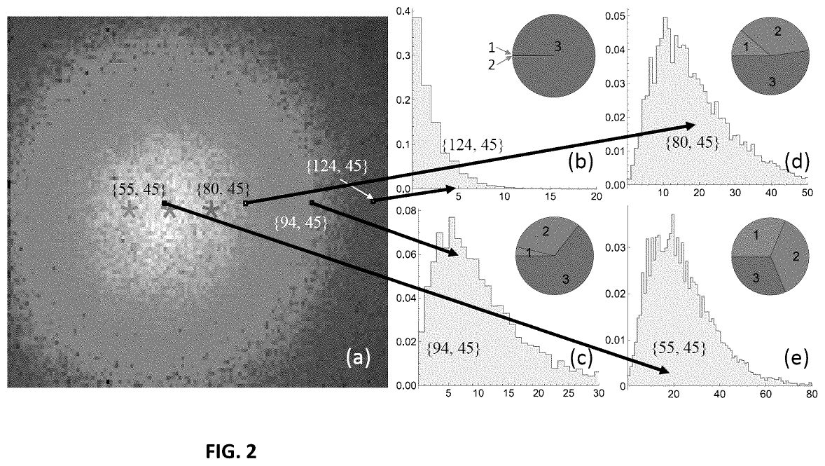

FIG. 2 shows an example of experimental data structure and light source reconstruction based on single-pixel data with the S-RIPE technique. FIG. 2 (a) shows an example of an intensity map of three thermal sources with spatial separation δx smaller than the point spread function (PSF) width σPSF. This separation is smaller than the Abbe-Rayleigh resolution criterion for a diffraction-limited PSF. However, if the PSF is well known, an accurate measurement with direct imaging (DI) may allow resolution beyond the criterion by fitting the intensity map with a known number of PSF. Therefore, we may compare the performance of exemplary super-resolution techniques to that of direct imaging that takes account of the PSF width.

The location of the sources is shown in FIG. 2 (a) with asterisks (source #1—left asterisk, source #2—center asterisk, source #3—right asterisk). Black arrows from certain pixels in (a) show corresponding photon number probability distributions experimentally measured by a photon-number-resolving camera and plotted in FIG. 2 (b)-(e). Numbers in curly brackets are pixels' coordinates. Pie chart insets (in FIG. 2 (b)-(e)) show the reconstructed relative contribution of the three modes to the photon number probability distributions. The contributions are proportional to the mean number of photons from each source detected in the pixels. The mean numbers of photons contributed to the photon number probability distributions are also extracted from the distributions themself, using the statistical mode reconstruction algorithm.

FIG. 2 (b) was obtained at the edge of the image, where most of the photons are coming from a single thermal source, resulting in a single-mode thermal PND. FIG. 2 (c,d) are for pixels closer to the center of the image; contributions of the two other sources increase, resulting in PNDs of multiple mixed thermal states. FIG. 2 (e) is for the center of the image. Here, all three sources contribute similarly, with the highest contribution being from source #2.

However, for best results, exemplary methods achieve super-resolution by treating the experimental data as a whole, including both the spatial location of pixels and the photon number probability distributions measured in each pixel. For comparison with direct imaging (DI), PNDs are replaced with a mean number of photons measured in each pixel. Then, we may use a nonlinear model fit (or other appropriate algorithm) to extract the mean number of photons and position of multiple light sources for both photon-number-resolved data and mean intensity maps. Note that this comparison is not entirely fair because DI does not allow determining the number of sources and their types. However, here, we will compare S-RIPE to DI, assuming the number of sources and their types to be known.

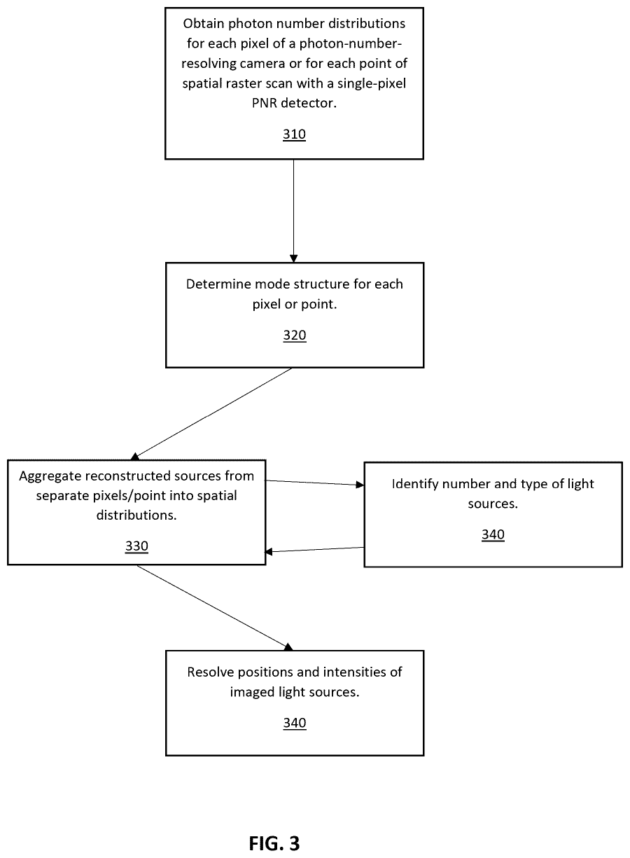

Referring now to FIG. 3, an exemplary method of super-resolving light sources is shown at 300.

At block 310, a photon number distributions (PNDs) for each pixel of a spatial image is obtained by a photon-number-resolving (PNR) camera or by spatial raster scan with a single-pixel PNR detector by producing a plurality of measurements of the image and statistically processing the photon numbers detected in all measurements for each pixel.

At block 320, the mode structure of the light in each pixel is obtained. The mode structure may be obtained via a mode reconstruction algorithm applied to each to each PND, e.g., as described in I. A. Burenkov, et al. PRA 95, 053806 (2017), the contents of which are hereby incorporated herein by reference in its entirety.

At block 330, sources reconstructed at independent pixels are aggregated into spatial distributions via separate fitting with a set of point-spread functions (PSFs). The number of PSFs can be defined as one for each light source identified from single-pixel data or by a separate procedure 340 for identification of the number and type of sources.

At block 340 the number of sources can be identified by increasing the number of sources in the fit model until fit returns one of the sources with extracted mean number of photons per unit of time per pixel (intensity, or similar measure of the amount of optical energy emitted by a light source) that is close to zero (i.e. below a user defined threshold).

At block 350, the positions and intensities of imaged light sources are resolved via analysis of the mean intensity distribution fit with PSFs.

The process described by blocks 330, 340, and 350 can be repeated several times, if desired, were positioning information from the previous iteration of block 350 is fed to the next iteration of block 330.

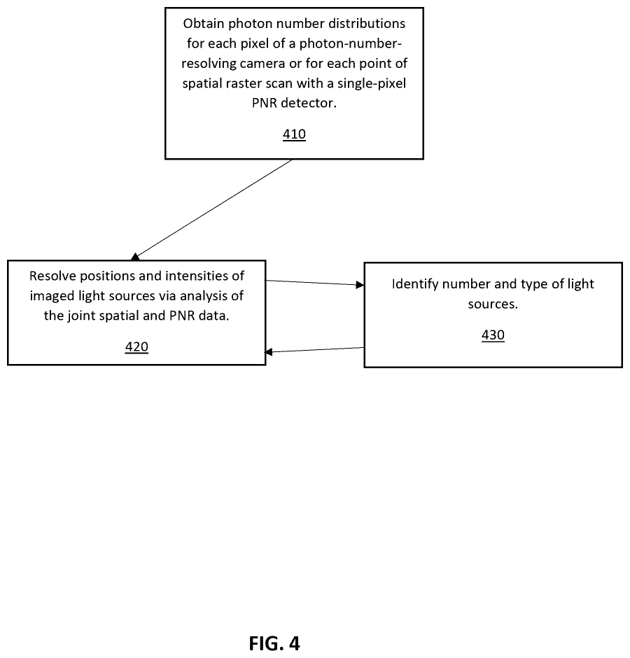

Referring now to FIG. 4, an exemplary method of super-resolving light sources is shown at 400.

At block 410, photon number distributions (PNDs) for each pixel of a spatial image is obtained by a photon-number-resolving (PNR) camera or by spatial raster scan with a single-pixel PNR detector by producing a plurality of measurements of the image and statistically processing the photon numbers detected in all measurements for each pixel.

At block 420, the positions and intensities of imaged light sources are resolved via analysis of the joint spatial and PNR data which takes PSF of the imaging system into account. Number of sources can be identified by a separate procedure 430.

At block 430 the number of sources can be identified by increasing the number of sources in the fit model of block 420 until fit returns one of the sources with extracted mean number of photons per unit of time per pixel (intensity, or similar measure of the amount of optical energy emitted by a light source) that is close to zero (i.e. below a user defined threshold).

If desired, the process in blocks 420 and 430 is iterated.

It is contemplated that an arbitrary number of sources can be used, e.g., in our proof of principle analysis up to 5 sources were used, and the number of sources is in principle unlimited.

Embodiments can include any type of source (classical or nonclassical), however number of sources with Poisson photon number statistics that can be separated by the method is limited to 1.

Both exemplary methods shown in FIGS. 3 and 4 can be applied to 1D, 2D or 3D spatial resolution.

An exemplary process for reconstructing the mode structure of conjugated sources of light using a photon-number-resolved joint probability distribution (JPD) is described herein. If no conjugated modes are present, the process below still applies, but the conjugated modes will not be occupied. An exemplary process identifies their basic components, a set of correlated and uncorrelated optical modes, thus enabling in situ characterization and remote sensing. Additionally, this method identifies the overall optical losses for conjugated fields, an otherwise difficult task in many cases where there is loss associated with the pair production medium itself. This method is loss tolerant and thus is directly applicable to realistic mesoscopic and macroscopic quantum states of light. The method can be used to determine the mode structure of mesoscopic states of light with a minimal set of assumptions, i.e., how to identify the number and statistical types of the modes from the same dataset.

Consider a JPD for two conjugated fields (CFs) in the general case. The two arms are denoted “signal” (s) and “idler” (i), respectively. They are comprised of one or more optical modes. There are perfectly conjugated modes that are generated as photons in pairs with a particular statistical distribution and independent losses for each mode in each arm. There are also uncorrelated fields in each arm. The total JPD P (nₛ, nᵢ) may be written in terms of underlying distributions. Here nₛ, nᵢ are the number of photons detected in the signal and idler arms respectively, and the underlying modes have probability distributions p_{μ}(n) for mean photon numbers μ, L_{n,k}(η)=ηⁿ(1−η)^{k-n}k!/[(k−n)!n!] are loss probability factors (LPF) s that compute a probability that n≤k photons are measured given transmittance η and k initial photons. This loss model enables reconstruction of light sources comprised of modes with any statistics. For all optical mesoscopic sources demonstrated to date, losses in an uncorrelated mode will only affect the mean photon number in that mode while leaving the statistics unaltered. Using this fact, we write the uncorrelated part of the JPD with loss-adjusted \tilde{μ}ⱼ=μⱼηⱼ, thereby significantly simplifying the evaluation of probabilities. Then the JPD P(nₛ, nᵢ) can be calculated as

$${P}_{c} ( {N}_{s} , {N}_{i} ) = \text{?} {\prod }_{j} {p}_{{μ}_{j}} ( {k}_{j} ) \text{?} , \qquad ( 1 )$$

$${P}_{u} ( M ) = \text{?} {\prod }_{j} \text{?} ( {k}_{j} ) ,$$

$$P ( {N}_{s} , {N}_{i} ) = \text{?} ,$$

$$\text{?} \text{indicates text missing or illegible when filed}$$

where P_{c} and Pᵤ are correlated and uncorrelated parts of the JPD.

For each mode, losses do not change the statistics, only the mean photon number μ. Note that in general, different modes may experience different losses due, for instance, to imperfect spatial overlap between emitted and collected light. Ordinarily, a nonlinear parametric fit could be employed on a measured JPD, to minimize Σ[(√xⱼ−√fᵢ)/σⱼ]², a typical scoring function, where xⱼ is the original vector, fⱼ is the fit vector, and σⱼ is the uncertainties vector. In general, a large number of free parameters results in ambiguous fits. The reconstruction based on JPD data can be applied in a generalized case of entangled light sources when conjugated photons can be measured independently by two PND detectors or 2 subarrays of the same PNR camera sensor.

Each of the two CFs can be assessed separately. No additional measurements are required for this analysis. One-dimensional (1D) reduced probability distributions (RPDs) for each field can be obtained from a JPD by a simple summation over rows and columns. Clearly, 1D RPDs fully describe modes that are present in each of the two conjugated fields. In addition, because the accuracy of a measured probability distribution is dominated by statistical uncertainty, summing over rows or columns of the 2D JPD means the 1D RPD has much lower statistical uncertainty.

Reconstruction of RPD is based on photon-number distribution given by Pᵤ(M) from Eq. (1). The modes that are identified through an RPD analysis unambiguously define a mode structure of the overall CFs to within transmittance losses. In addition, modes cannot be designated as correlated or uncorrelated through an RPD reconstruction.

In case of incoherent and uncorrelated light sources, such as fluorescent biomarkers in fluorescent microscopy or astrophysical thermal sources in remote planetary systems, there is no JPD, and analysis equivalent to RPD analysis of Pᵤ(M) from Eq. (1) should be applied to the PNR data consequently as in the block 320 or jointly as in the block 430 with the spatial data (FIGS. 3 and 4).

To include spatial dimensions, appreciate that the mode originating from a point source is imaged to a PSF of the imaging device. For a given mean photon number of the point source mode, the mean photon numbers due to this mode will be distributed over a plurality of pixels according to PSF and can be easily found. Therefore, to reduce the number of parameters in the fit the mean photon number of the point source mode, and its spatial position can be the only fit parameters for each point source. The global fitting procedure then will derive the contributions from each point source mode to each pixel of the image and optimize thus reduced parameters to minimize a global scoring function.

This method is limited mainly by the maximum photon number detected and the total amount of data accumulated. The total amount of data accumulated sets a shot-noise level for that data, which directly affects the accuracy of any reconstruction. The highest resolved photon-number state limits the number of modes that can be reconstructed. This is particularly important for determining the presence of a Poissonian mode rather than several similar thermal modes. Naturally, the mean number of photons of the point source improves both the reconstruction accuracy and the maximum possible number of reconstructed modes. Thus, this method is well-scalable for brighter mesoscopic states.

A reconstruction through photon-number statistics works well when the number of modes and their types are known beforehand. Furthermore, adding unoccupied modes to the reconstruction only requires expanding experimental data sets to achieve the same accuracy, but otherwise does not negatively affect the reconstruction. However, not including all modes present in a reconstruction leads to significant errors in the entire set of recovered parameters. In the most general case, it is useful to establish a method to identify an a priori unknown mode structure based on a series of reconstructions, a situation typical for the experimental data.

Herein is presented details of how to reconstruct such a mode structure. Recovered sets of fitting parameters [symbol] _{recovered} may be used together with their corresponding absolute fitting errors,

$$√ \sum {( {x}_{j} - {f}_{j} )}^{2} ,$$

where xⱼ represents the simulated probability distribution and fⱼ represents the recovered probability distribution.

In most cases, it is important to determine if a Poisson mode is present, or a distribution can be well described by a finite number of thermal modes. In some cases, a Poisson mode can be due to e.g. background or dark counts on the pixel and should therefore be removed for better convergence. In other cases, if there is one source of Poisson-distributed photons in the object plane, its position can also be super-resolved with this method. In the above, only one Poisson source can be identified. A maximally uncorrelated state with N thermal modes occurs when all the modes are equally populated. Therefore, if reconstructions yield mode populations that depend on the number of thermal modes allowed, the number of thermal modes in the reconstruction should be increased (and a Poissonian mode allowed) until the reconstruction no longer depends on the number of modes allowed (this procedure can be applied in the blocks 340 and 430). The size of the experimental data set, including both the maximum photon number detected and the amount of data, will ultimately limit the number of modes that can be included in an accurate reconstruction.

Shot noise must always be considered in analyzing the accuracy of a method for characterization based on optical detection. Additionally, truncating detection at some photon number Nmax limits the accuracy of the extracted photon-number probabilities. This method, with detection of photon numbers larger than the number of modes present, is robust against shot noise over a range of total mean photon number. Typically, the uncertainty for p(nₛ, nᵢ) where nₛ, nᵢ photons are detected in the idler and signal arms respectively can be estimated from the shot-noise limit under the assumption that trials are independent.

The dependence of the quality of the reconstruction, defined as the mean deviation of the error of reconstruction from the ground truth, on the size of the pixel of the camera is minimal so long as the point spread function size is larger than the size of one pixel. Once the point spread function becomes much smaller in size than the pixel size, the quality of the reconstruction decreases significantly. This observation enables significant flexibility in choosing the size of the pixel in the imaging system, at least in the ideal situation of a noiseless camera.

There are 4 possible methods to modify the pixel size in the super-resolving system. First, the imaging sensor with a different pixel size can be chosen. Second, the imaging system can be arranged to focus on a different area size of the existing sensor. Third, the photon number output of several adjacent pixels in each frame can be added, before calculating the photon number statistics. Fourth, the photon number statistics obtained for each pixel (in many frames) can be obtained first and then combined for the adjacent pixels. In the latter case, one can, for example, average the adjacent histograms, assuming that the underlying photon number distributions are nearly the same.

The exact method of modification of the pixel size may depend on the properties of the photon-number resolving camera, the object under measurement, and the physical limitations (e.g. size) of the optical imaging system. The third method is likely the most flexible and, therefore, the most efficient for the ideal (noiseless) sensors (cameras or single photon detectors). However, readout noise and its properties can influence the ultimate decision. For example, readout noise can be an additive Poisson-distributed background. In this case, even though the use of the third method adds Poisson-distributed backgrounds of all the pixels that are added up, S-RIPE can identify the Poisson component in the photon number distribution. By subtracting the Poisson component from the photon number distribution, we can still recover all the statistical properties of thermal and single-photon sources that remain. In other cases, the additive background can be significantly non-Poissonian. If properly characterized, their contribution can also be subtracted, but that would require the characterization of the noise properties of each pixel separately.

In an embodiment, an algorithm for the mode structure reconstruction for a single pixel [see, e.g., PRA 95, 053806 (2017), which is incorporated herein by reference in its entirety] quantifies and separates contributions of many sources to the pixel's illumination.

Embodiments include a photon-number-resolving (PNR) camera that acquires photon number distributions or spatial raster scan with a single-pixel PNR detector acquiring PNDs for each pixel of the spatial image. Embodiments include applying statistical methods to separate sources to individual pixels of the same image and consequential aggregation into spatial distributions via separate fitting with a set of a point-spread functions.

Embodiments include applying statistical methods to separate sources to joint subsets or entire spatial and PND distributions via fitting the whole data by joint spatial and PNR models. Exemplary method is described below:
1) As in block 410 of FIG. 4 obtain PND for each pixel of a spatial image is obtained by a photon-number-resolving (PNR) camera or by spatial raster scan with a single-pixel PNR detector.
2) Using known point spread function of the imaging system (lenses, objectives, microscopes, telescopes), or a model PSF such as Gaussian distribution with unknown height, width and center created a model of how each point source will illuminate the camera pixels (or point of the raster scan) depending on its position in the object plane (x₀,y₀) . . . (xₙ,yₙ) and mean number of photons emitted per unit of time. Calculate the initial intensity distribution in pixels l_{(x,y)} from the initial guess of the model parameters: type and number of light sources, their positions, and mean number of photons emitted per unit of time (PSF width if unknown).
3) For N point sources, using individual intensity distributions and photon number statistics for each source, apply PSF to obtain a model of the resulting photon number statistics for each pixel (or point of the raster scan) depending on the position of the light sources, the mean number of photons emitted per unit of time, and the type of sources PND_{(x,y,k)}[x₀, y₀, . . . , xₙ, yₙ, lₒ, . . . lₙ], where k=number of photons.
4) Build a cost function that measures how close the observed PND_{(x,y,k)} data can be explained by PND_{(x,y,k)}[x₀, y₀, . . . , xₙ,yₙ, lₒ, . . . lₙ]
5) Minimize the cost function by adjusting [x₀,y₀, . . . , xₙ, yₙ, lₒ, . . . lₙ]
6) One possible cost function is:

$$\sum \frac{PN {D}_{( x , y , k )} - PN {{D}_{( x , y , k )} [ {x}_{0} , {y}_{0} , … , {x}_{n} , {y}_{n} , {I}_{0} , … {I}_{n} ]}^{2}}{{σ}_{( x , y , k )}} \qquad ( 2 )$$

where σ_{(x,y,k)} is experimental uncertainty, e.g. defined by the measurement shot-noise.
7) One possible minimization strategy is the Levenberg-Marquardt algorithm.

As those familiar with the art can appreciate, in leu of steps 6 and 7, maximum likelihood estimation can be used.

Embodiments include obtaining super-resolution and source localization enhancement using a photon-number-resolving camera or single-pixel PNR detector and off-the-shelf components. Embodiments include resolving five strongly (significantly beyond Rayleigh's limit) overlapping thermal sources or single-photon sources and recovering their intensities.

There are other super-resolution methods, but each method has its unique limitations (there is no universal super-resolution method). Our technique allows the resolution of a large number (>2) of unbalanced thermal and/or single-photon sources and does not require switchable dyes or patterned illumination, which is unachievable with existing techniques. Because this method is different from other super-resolution methods it can cover a different sub-set of imaging problems, and it is particularly useful for single emitters (e.g., fluorescent biomarkers, such as fluorophores, NV-centers, quantum-dots). Further, no other known method enables counting the number of sources and measure intensities of each source even if their relative position cannot be resolved due to overlap.

Many super-resolving imaging systems demonstrated to date can be combined with (and enhanced) with exemplary methods. To do so, photon number-resolving cameras (or detectors) should be used instead of their original sensors.

Embodiments can include single-molecule localization microscopy (SMLM) and stellar observations. Fundamental and practical properties (such as maximal Fisher information, fundamental and practical limits to super-resolution, etc.) of this technology can be determined. Embodiments can involve thermal light sources, a single-photon light sources, or a combination thereof with up to one Poissonian (laser) source.

The algorithm provides a self-estimate of the accuracy of mode position measurement through residual analysis, e.g. for an unweighted least-squares function PND_{(x,y,k)}-PND_{(x,y,k)}[x₀, y₀, . . . , xₙ, yₙ, lₒ, . . . lₙ] the covariance matrix should be multiplied by the variance of the residuals of the best-fit

$$σ = \sum \frac{P N {D}_{( x , y , k )} - PN {{D}_{( x , y , k )} [ {x}_{0} , {y}_{0} , … , {x}_{n} , {y}_{n} , {I}_{0} , … {I}_{n} ]}^{2}}{{N}_{data} - {N}_{parameters}} \qquad ( 3 )$$

to give the variance-covariance matrix σ²C. This estimates the statistical error on the best-fit parameters from the scatter of the underlying data [see for a detailed description of the algorithm implementation: https://www.gnu.org/software/gsl/doc/html/nls.html]. In some embodiments, the algorithm's output is related to the self-estimate of accuracy of super-resolution.

Conventional approaches to super-resolution can be enhanced with the herein described photon number resolving detection. The following is incorporated herein by reference in its entirety: ChemPhysChem 13, 1986-2000 (2012), Nature Methods 3, 793-796 (2006), Science 313, 1642-1645 (2006), https://patents.google.com/patent/EP4246205A1/en

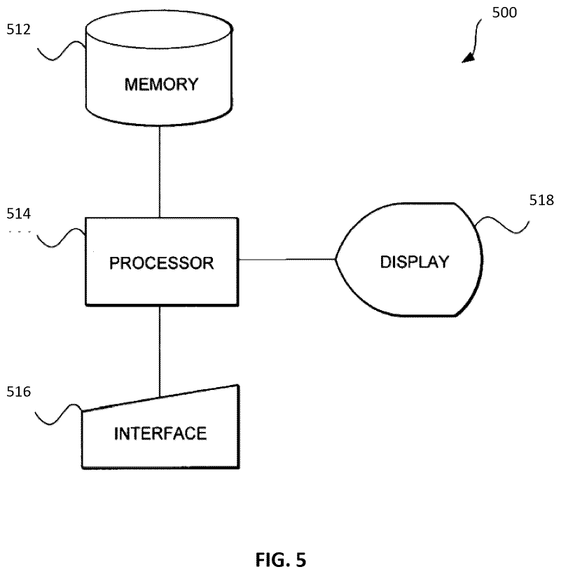

It should be understood that the calculations and processes described herein may be performed by any suitable computer system, such as that diagrammatically shown in FIG. 5. Data is entered into system 500 via any suitable type of user interface 516, and may be stored in memory 512, which may be any suitable type of computer readable and programmable memory and is preferably a non-transitory, computer readable storage medium. Calculations are performed by processor 514, which may be any suitable type of computer processor and may be displayed to the user on display 518, which may be any suitable type of computer display. Processor 514 may be associated with, or incorporated into, any suitable type of computing device, for example, a personal computer or a programmable logic controller. The display 518, the processor 514, the memory 512 and any associated computer readable recording media are in communication with one another by any suitable type of data bus, as is well known in the art.

Examples of computer-readable recording media include non-transitory storage media, a magnetic recording apparatus, an optical disk, a magneto-optical disk, and/or a semiconductor memory (for example, RAM, ROM, etc.). Examples of magnetic recording apparatus that may be used in addition to memory 512, or in place of memory 512, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. It should be understood that non-transitory computer-readable media include all computer-readable media except for a transitory, propagating signal.

The processes described herein may be embodied in, and fully automated via, software code modules executed by a computing system that includes one or more general purpose computers or processors. The code modules may be stored in any type of non-transitory computer-readable medium or other computer storage device. Some or all the methods may alternatively be embodied in specialized computer hardware. In addition, the components referred to herein may be implemented in hardware, software, firmware, or a combination thereof.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

Any logical blocks, modules, and algorithm elements described or used in connection with the embodiments disclosed herein can be implemented as electronic hardware, computer software, or combinations of both. To clearly illustrate this interchangeability of hardware and software, various illustrative components, blocks, modules, and elements have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described or used in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix(s) as used herein is intended to include both the singular and the plural of the term that it modifies, thereby including at least one of that term (e.g., the colorant(s) includes at least one colorants). Option, optional, or optionally means that the subsequently described event or circumstance can or cannot occur, and that the description includes instances where the event occurs and instances where it does not. As used herein, combination is inclusive of blends, mixtures, alloys, reaction products, collection of elements, and the like.

As used herein, a combination thereof refers to a combination comprising at least one of the named constituents, components, compounds, or elements, optionally together with one or more of the same class of constituents, components, compounds, or elements.

All references are incorporated herein by reference.

The use of the terms “a,” “an,” and “the” and similar referents in the context of describing the invention (especially in the context of the following claims) are to be construed to cover both the singular and the plural, unless otherwise indicated herein or clearly contradicted by context. It can further be noted that the terms first, second, primary, secondary, and the like herein do not denote any order, quantity, or importance, but rather are used to distinguish one element from another. It will also be understood that, although the terms first, second, etc. are, in some instances, used herein to describe various elements, these elements should not be limited by these terms. For example, a first current could be termed a second current, and, similarly, a second current could be termed a first current, without departing from the scope of the various described embodiments. The first current and the second current are both currents, but they are not the same condition unless explicitly stated as such.

The modifier about used in connection with a quantity is inclusive of the stated value and has the meaning dictated by the context (e.g., it includes the degree of error associated with measurement of the particular quantity). The conjunction or is used to link objects of a list or alternatives and is not disjunctive; rather the elements can be used separately or can be combined together under appropriate circumstances.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method of super-resolving light sources comprising the steps of:
obtaining a respective photon number distribution for each pixel of a spatial image obtained by a photon-number-resolving device;
representing at least one of a plurality of light sources as spatial distributions of mode structures via a point-spread function; and
finding a configuration of light sources that best represents an observed plurality of photon number distributions of at least one of the plurality of pixels,
wherein the configuration includes at least one of a number or spatial position of the light sources in an object plane.

2. The method of claim 1, further comprising the step of:
determining intensity information of each light source imaged by the camera.

3. The method of claim 1, further comprising the step of:
determining location information of each light source imaged by the camera.

4. The method of claim 1, further comprising the step of:
determining a mode structure via a mode reconstruction algorithm applied to each pixel.

5. The method of claim 4, wherein the mode reconstruction algorithm includes:
identifying a set of correlated and uncorrelated optical modes.

6. The method of claim 5, wherein the mode reconstruction algorithm includes identifying overall optical losses for conjugated fields.

7. The method of claim 1, further comprising:
identifying a number of sources by increasing number of sources in a fit model until the fit model returns one of the sources with extracted mean number of photons per unit of time per pixel that is below a user defined threshold.

8. The method of claim 1, further comprising calculating a joint probability distribution using the equation:
$${P}_{c} ( {N}_{s} , {N}_{i} ) = \text{?} {\prod }_{j} {p}_{{μ}_{j}} ( {k}_{j} ) \text{?} ,$$
$${P}_{u} ( M ) = \text{?} {\prod }_{j} \text{?} ( {k}_{j} ) ,$$
$$P ( {N}_{s} , {N}_{i} ) = \text{?} ,$$
$$\text{?} \text{indicates text missing or illegible when filed}$$
where nₛ, nᵢ are the number of photons detected in signal and idler arms, respectively, underlying modes have probability distributions p_{μ}(n) for mean photon numbers μ, L_{n,k}(η)=ηⁿ(1−n)^{k-n}k!/[(k−n)!n!] are loss probability factors that compute a probability that n≤k photons are measured given transmittance η and k initial photons, and P_{c} and Pᵤ are correlated and uncorrelated parts of the joint probability distribution, respectively.

9. The method of claim 8, further comprising the step of:
minimizing an error of nonlinear parametric fit of the joint probability distribution to determine the number and type of light sources imaged by the camera.

10. The method of claim 1, wherein the photon-number-resolving device is a photon number resolving camera.

11. The method of claim 1, wherein the photon-number-resolving device is a photon number resolving detector using raster scanning.

12. A method of super-resolving light sources comprising the steps of:
obtaining photon number distributions for each pixel of a spatial image by a photon-number-resolving device; and
resolving positions and intensities of imaged light sources via analysis of joint spatial, photon-number-resolving data, and a point-spread function of the imaging system.

13. The method of claim 12, wherein the photon-number-resolving device is a photon number resolving camera.

14. The method of claim 12, wherein the photon-number-resolving device is a photon number resolving detector using raster scanning.

15. The method of claim 12, further comprising:
identifying a number of sources by increasing number of sources in a fit model until the fit model returns one of the sources with extracted mean number of photons per unit of time per pixel that is below a user defined threshold.

16. A super-resolution system for super-resolving light sources comprising:
a photon-number-resolving device;
a processor configured to:
obtain photon number distributions for each pixel of a spatial image from the photon-number-resolving device; and
resolve positions and intensities of imaged light sources via analysis of joint spatial, photon-number-resolving data, and a point-spread function of the super-resolution system.

17. The super-resolution system of claim 16, wherein the photon-number-resolving device is a photon number resolving camera.

18. The super-resolution system of claim 16, wherein the photon-number-resolving device is a photon number resolving detector using raster scanning.

19. The super-resolution system of claim 16, wherein the processor is further configured to:
identify a number of light sources by increasing number of light sources in a fit model until the fit model returns one of the light sources with extracted mean number of photons per unit of time per pixel that is below a user defined threshold.
